(19) United States
(12) Patent Application Publication
(10) Pub. No.: US 2014/0214217 A1
(43) Pub. Date: Jul. 31, 2014

(54) Method for Configuring a Control Device of a Thermodynamic System

(71) Applicant: Commissariat a L'energie Atomique et aux Energies Alternatives, Paris (FR)

(72) Inventors: Francois Bonne, Grenoble (FR); Patrick Bonnay, Voiron (FR)

(21) Appl. No.: 14/166,125

(22) Filed: Jan. 28, 2014

(30) Foreign Application Priority Data
Jan. 29, 2013 (FR) 1350749

(51) Int. Cl. G05D 23/19

(52) U.S. Cl. CPC G05D 23/19
USPC 700/281

(57) ABSTRACT

Method for configuring a control device of a thermodynamic system, in particular a thermohydraulic system, especially of a cryorefrigerator system, wherein the method comprises the following phases:
Implementation of a method of determination of a model of a thermodynamic system, wherein the determination method comprises a decomposition of the system into sub-systems each having boundary conditions, wherein:
   output, respectively input, boundary conditions of a sub-system are linked to input, respectively output, boundary conditions of a neighbouring sub-system,
   the boundary conditions pertain at least to an amount of fluid per unit time and to a pair of physical quantities defining the thermodynamic state of the fluid;
Generation of an observer by using the model determined in the previous phase.

The present invention relates to the field of systems modelling. In particular, the invention relates to a method for obtaining or determining a model of a thermodynamic system. The invention also relates to a method for configuring a control device of a thermodynamic system. The invention further pertains to a recording medium readable by a processor on which are recorded data defining such a model. The invention further pertains to a control device of such a thermodynamic system. The invention pertains finally to a system comprising such a device.

More exactly, the invention relates to the generation of gains and of structures of observers for estimating a steady or unsteady thermal loading applying to the cryogenic liquid bath of a cryorefrigerator, for example a helium bath. The usefulness of an observer of such a thermal loading is to make it possible to manage dynamic operations of systems.

To obtain maximum performance, or else obtain formal proofs of stability (beneficial within the context of the use of a machine whose operation is critical), it is necessary to design observation gains and structures on the basis of models, optionally parametrized. These models can be obtained for example by a procedure called “identification” and based on the existence of experimental data. The user of the system must generate a scenario which allows him to recover experimentation data. These data are thereafter processed by virtue of specific algorithms, which make it possible to obtain a model that is usable in an observation strategy. This procedure has the drawback of requiring that the system actually exists, that is to say that it is constructed, available and in operation. It is therefore not possible to issue specifications or to design observers a priori.

In document FR2943768, a method for estimating a heating is proposed. The method relies on the use of an observer using solely variables considered significant from among two sub-systems used in cryogenics, a phase separator and a Joule-Thompson expansion valve. The model serving for observation is obtained by identification, stated otherwise, after selecting the variables (or multiplication of variables) comprising information apt to be used for observation, an identification algorithm is charged with constructing a numerical model linking the evolution of these variables, as a function of one another.

Thus, this method comprises several disadvantages:
It can only be designed (and moreover executed) a posteriori, the identification algorithm using scenarios having already taken place on the machine,
It takes into account only certain non-linearities assumed a priori by the designer. Certain couplings may therefore be omitted.

It is known to use a physical model to describe the behaviour of a system. Unfortunately, such a model may exhibit a complexity which does not allow the synthesis of correctors or of observers. The proposed models are also not all linearizable on account of the presence of tests. Neither do these models explicitly give the direction of propagation of all the boundary conditions applied to them. Some are models which reflect only the steady state.

The aim of the invention is to provide a method for the determination of a model of a thermodynamic system, making it possible to remedy the problems mentioned previously and improving the methods of determination known from the prior art. In particular, the invention proposes a method of determination not requiring an actual realization of a system and therefore not making it necessary to carry out measurements on such a system in operation, these measurements running the risk moreover of being marred by errors. The invention also pertains to a recording medium. The invention further pertains to a control device of a thermodynamic system. The invention pertains finally to a system comprising such a device.

The invention relates to a method for configuring a control device of a thermodynamic system, in particular a thermohydraulic system, especially of a cryorefrigerator system. The method comprises the following phases:
Implementation of a method of determination of a model of a thermodynamic system;
Generation of an observer by using the model determined in the previous phase,
   wherein the phase of implementation of the method of determination of a model comprises a decomposition of the system into sub-systems each having boundary conditions. Moreover, output, respectively input, boundary conditions of a sub-system are linked to input, respectively output, boundary conditions of a neighbouring sub-system and the boundary conditions pertain at least to an amount of fluid per unit time and to a pair of physical quantities defining the thermodynamic state of the fluid.

The pair of physical quantities can comprise the temperature of the fluid and/or the pressure of the fluid.

It is possible to use physical models of the sub-systems based on the operation of each sub-system.

It is possible to implement a step of linearizing the physical models of the sub-systems.

It is possible to implement a step of initializing the physical models of the sub-systems at an operating point of the system, especially at a steady operating point of the system.

It is possible to implement a step of determining the model of the system by combining the models of the sub-systems.

The invention also pertains to a method of control of a thermodynamic system, in particular a thermohydraulic system, especially of a cryorefrigerator system, comprising the use of an observer generated by implementing the previously defined configuration method.

The invention also relates to a method of determination of a model of a thermodynamic system, in particular a thermohydraulic system, especially of a cryorefrigerator system, comprises a decomposition of the system into sub-systems each having boundary conditions. Moreover, output, respectively input, boundary conditions of a sub-system are linked to input, respectively output, boundary conditions of a neighbouring sub-system and the boundary conditions pertain at least to an amount of fluid per unit time and to a pair of physical quantities defining the thermodynamic state of the fluid.

The invention further relates to a recording medium readable by a processor on which are recorded data defining a model of a thermodynamic system, in particular a thermohydraulic system, especially of a cryorefrigerator system, the model being obtained by implementation of a previously defined method.

According to the invention, the control device of a thermodynamic system, in particular a thermohydraulic system, especially of a cryorefrigerator system, comprises hardware and/or software elements for using a model obtained by the implementation of a previously defined method.

The hardware and/or software means can comprise hardware and/or software elements for determining at least one control by using a model obtained by the implementation of a previously defined method.

The hardware and/or software means can comprise a previously defined recording medium, like a memory.

According to the invention, the thermodynamic system, in particular thermohydraulic system, especially a cryorefrigerator system, comprises a previously defined control device.

The appended drawings represent, by way of example, an embodiment of a monitoring device according to the invention.

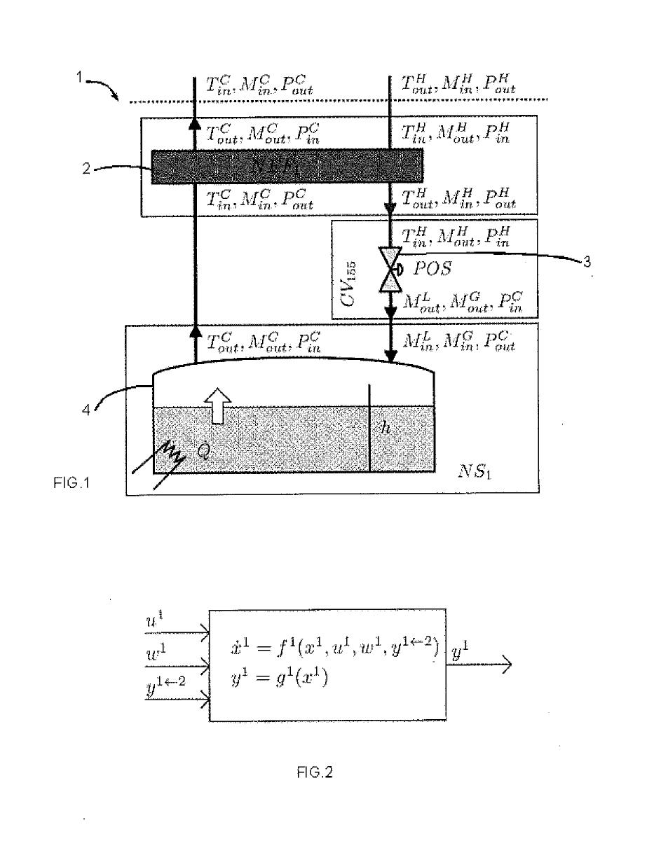

FIG. 1 is a diagram of a first embodiment of a cryorefrigerator system according to the invention.

FIG. 2 is a diagram illustrating a model of an element of the first embodiment of the cryorefrigerator system according to the invention.

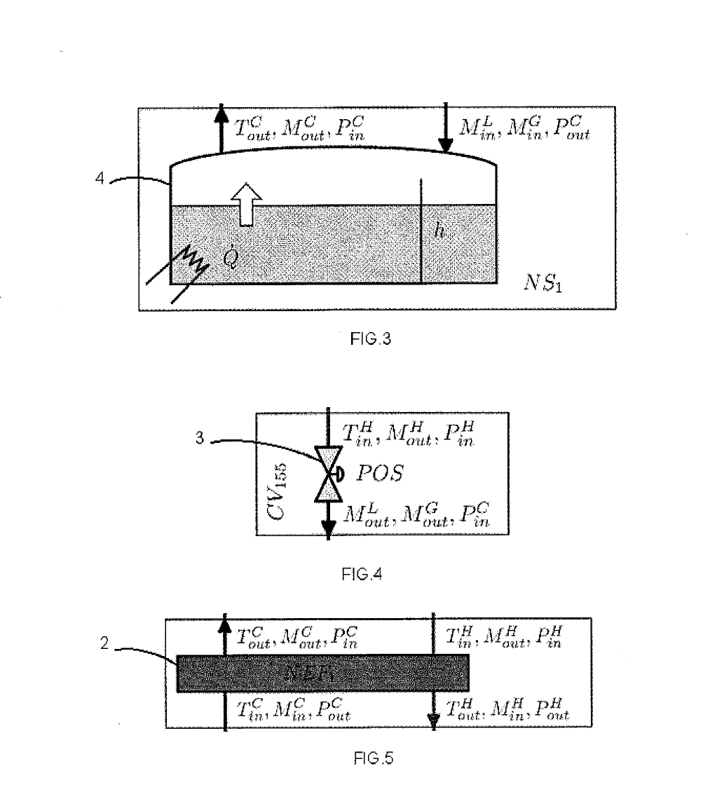

FIG. 3 is a diagram of a phase separator of the first embodiment of the cryorefrigerator system according to the invention.

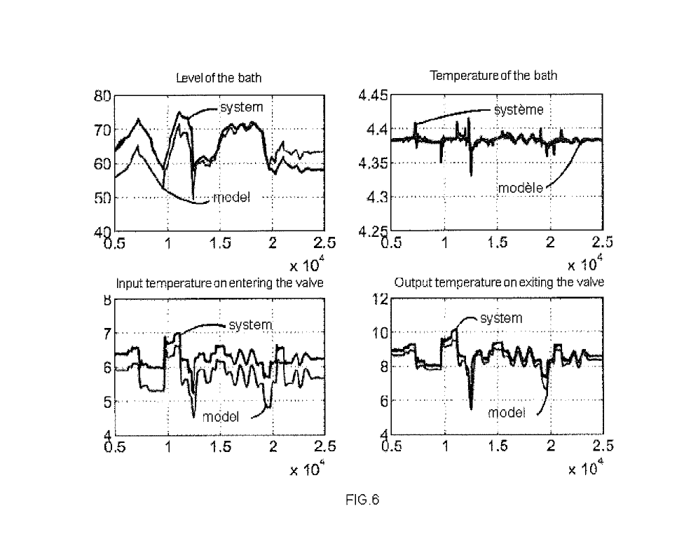

FIG. 4 is a diagram of a valve of the first embodiment of the cryorefrigerator system according to the invention.

FIG. 5 is a diagram of an exchanger of the first embodiment of the cryorefrigerator system according to the invention.

FIG. 6 is a set of graphs illustrating the operation of the first embodiment of the cryorefrigerator system according to the invention.

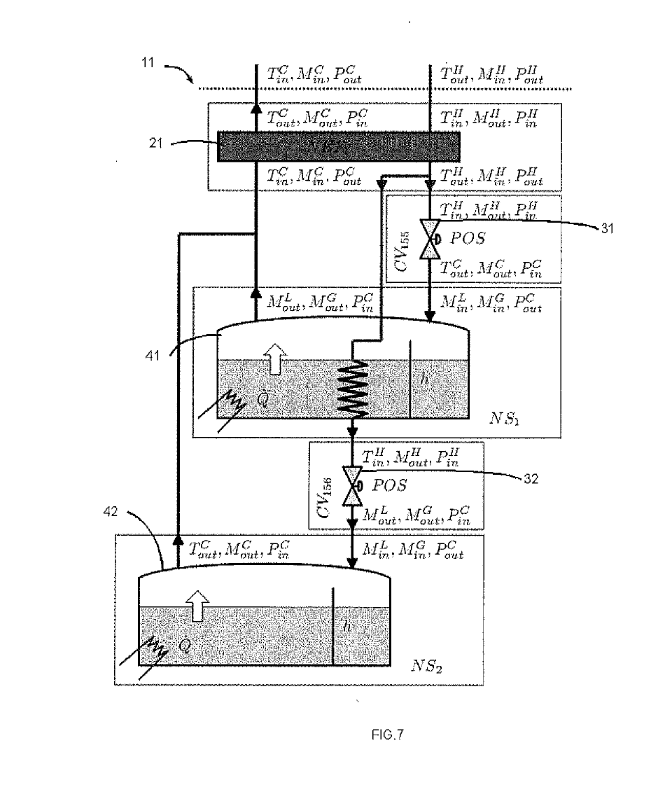

FIG. 7 is a diagram of a second embodiment of a cryorefrigerator system according to the invention.

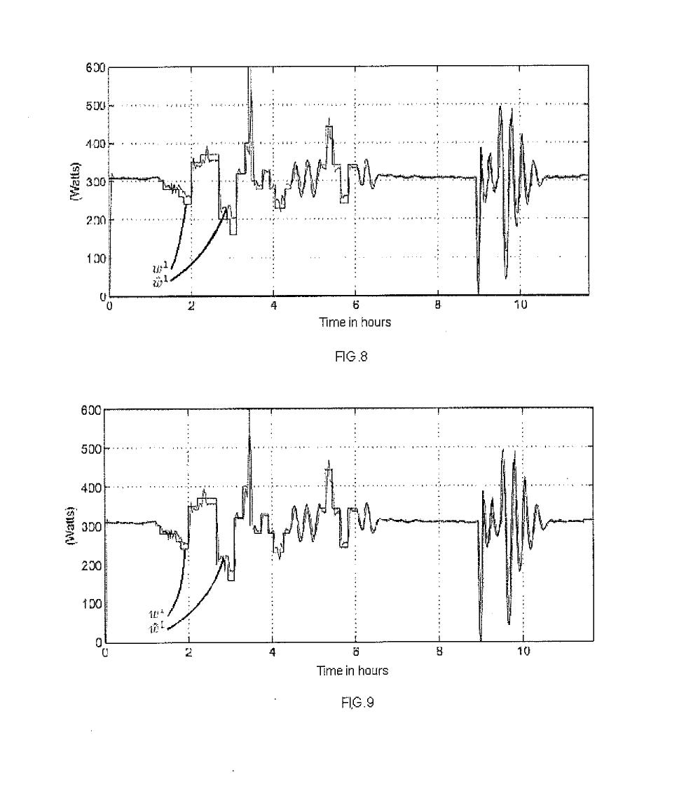

FIGS. 8 and 9 are graphs illustrating the operation of the second embodiment of the cryorefrigerator system according to the invention.

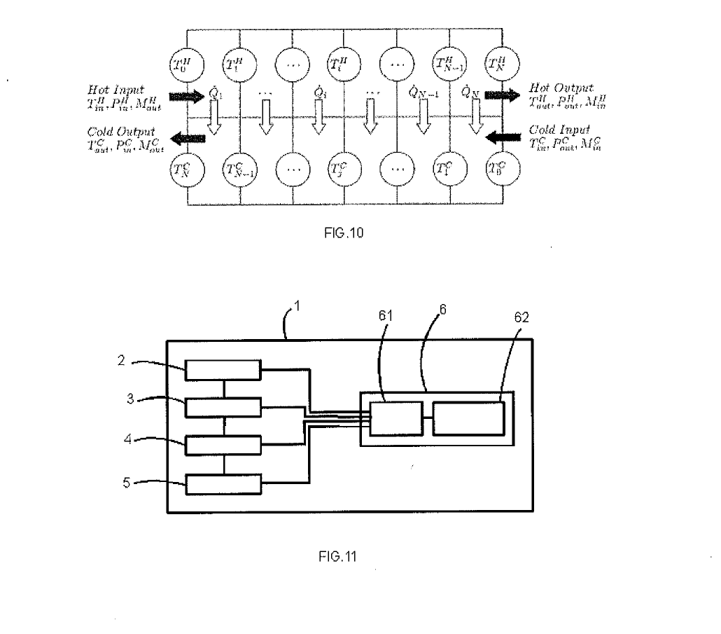

FIG. 10 is an exemplary spatial discretization model of a counter-current exchanger.

FIG. 11 is another diagram of the first embodiment of a cryorefrigerator system according to the invention.

A first embodiment of a thermodynamic system is described hereinafter with reference to FIGS. 1 and 11. The system is for example a thermohydraulic system, especially a cryorefrigerator system. The system comprises several sub-systems, for example an exchanger 2, for example a counter-current exchanger, a valve 3, especially a Joule-Thompson expansion valve, a phase separator 4 and optionally one or more other sub-system 5. A heat-transfer fluid traverses these various sub-systems so as to allow thermal exchanges between the system and at least two media outside the system.

The system also comprises a control device 6. The control device makes it possible to generate control commands for at least some of the sub-systems (some of the sub-systems like the exchanger might not be controlled), especially positioning control commands for the valve. The control device can also comprise sensors making it possible to measure operating parameters of the system 1. Such measurements can also be used by the control device to define control commands.

The control device comprises hardware and/or software elements 61, 62 for use of a model. The elements comprise a microprocessor 61 and a recording medium 62 readable by the microprocessor 61, especially a memory. To determine control commands, the control device uses a model of the system 1 placed in memory in the memory 62. These control commands can be generated by the microprocessor 62 at the level of the latter. The model of the system is, preferably, defined by implementation of a method of determination according to the invention. An embodiment of such a method of determination according to the invention is described below.

A second embodiment of a thermodynamic system is described hereinafter with reference to FIG. 7. The second embodiment of the system differs for example from the first embodiment of the system in that it comprises moreover a second phase separator 42 and a second valve 32. A second exchanger is situated in the first phase separator 41. The heat-transfer fluid passes through the second exchanger and then meets the second phase separator after having passed through the second valve 32.

A mode of execution of a method for determining a model of a thermodynamic system is described hereinafter.

It comprises a step of decomposing the system into several sub-systems 2, 3, 4, 5; 21, 31, 41, 32, 42 each having boundary conditions.

The output, respectively input, boundary conditions of a sub-system are linked to input, respectively output, boundary conditions of a neighbouring sub-system, that is to say of a sub-system with which it is directly linked, stated otherwise of a sub-system to which it directly dispatches the heat-transfer fluid or of a sub-system from which it directly receives the heat-transfer fluid.

The boundary conditions pertain to at least one amount of fluid per unit time, especially a heat-transfer fluid flowrate, and to a pair of physical quantities defining the thermodynamic state of the fluid, especially a temperature of the fluid and a pressure of the fluid.

Advantageously, use is made of physical models of the sub-systems based on the operation of each sub-system.

Preferably, a step of linearizing the physical models of the sub-systems is implemented.

It is also possible advantageously to implement a step of initializing the physical models of the sub-systems at an operating point of the system, especially at a steady operating point of the system.

The model of the system is thereafter obtained by combining the various models of the sub-systems.

This is illustrated in greater detail hereinbelow.

In the mode of execution, there is proposed an approach through physical equations but by taking special boundary conditions. In a standard manner, the system is split up into sub-systems whose operation is simpler to model. But, in contradistinction to the prior art where the variables and boundary conditions are chosen as a function of the direction of flow of the fluid in the system, other variables and boundary conditions such that to each “incoming” condition of a sub-system there corresponds an “outgoing” condition of the neighbouring or juxtaposed sub-system and that there exists at least one pair of quantities which makes it possible to define the thermodynamic state of the fluid.

The mode of execution is based on the construction of a model cast as physical equations. The model therefore involves solely the physical quantities (specific heats, volumes, densities, areas, viscosity, latent heats, etc.) of the method used. All these data are known, or can be chosen a priori. It therefore entails establishing a model of the object or of the system whose thermal loading it is desirable to observe.

In particular, it is proposed to obtain models cast as physical equations to estimate the thermal loading applying to a heat-transfer fluid bath such as a helium bath of a cryorefrigerator. Accordingly, it is possible to propose several observers based on the experimentally validated model.

Thus, the estimation method no longer relies on the use of experimental data, but on the physical knowledge of the operation of the system. We will thus use all the relations useful for modelling the system. By using a model based on the physical equations, in particular all the known non-linearities of the system are naturally taken into account in estimating the thermal loading.

It is imperative to write models dedicated to checking and to observation, reflecting solely the main characteristics of the sub-systems studied (so as to limit the complexity). For each sub-system, the direction of propagation of the boundary conditions is defined while paying attention that they be compatible between sub-systems, so as to connect them subsequently (in order to obtain the model of the system).

Linearizable models are chosen. Models that can be initialized at an operating point are also chosen. Indeed, for the synthesis of an observer, the models must be initialized around a steady operating point. This step is tricky since the steady state of each sub-system depends on the state of the sub-systems which are connected to it.

For example, to estimate the thermal loadings applied to the heat-transfer fluid bath of the system of FIG. 1, an 800 W cryorefrigerator at 4.4K is considered. The Joule-Thompson cycle of this system is considered in particular.

As represented in FIG. 3 and as seen above, the system operating according to the Joule-Thompson cycle comprises an expansion valve termed a “Joule-Thompson valve”, a phase separator, and a counter-current heat exchanger. In the phase separator, a heating device which dissipates thermal power makes it possible to simulate thermal loadings applied to the bath.

In FIG. 3 are represented the boundary conditions which have been chosen to model the three sub-systems constituting the system. Each of the sub-systems each having three variables, for example a variable T (for a temperature) and P (for a pressure) and M (for a mass flowrate) (or other combinations of the variables chosen from among T, P, M, H or enthalpy, ρ or density) having the index “in”, sees its neighbouring system have the same variable, this time with the index “out”. Some of the input boundary conditions of the sub-systems are normally used as output boundary conditions (and vice versa), the choice of boundary conditions makes it possible to assemble or to combine the sub-systems so as to culminate in the model of the system.

Before writing the models, whether the model of the system as a whole or the various models of the sub-systems, the vocabulary which will be used is stated. FIG. 2 represents a block containing a model in standard form, with inputs and outputs identifiable by the direction of the arrows.

The set of inputs/outputs of the sub-system 1 is delineated here:
u¹ represents the controllable input vector (or the one which can be manipulated, that on which it is possible to act),
x¹ represents the state vector of the model (the internal variables),
\dot{x}¹ represents the expression “the variation of x¹” with respect to time

$$( {\dot{x}}^{1} = \frac{\partial {x}^{1}}{\partial t} ) ,$$

w¹ represents the uncontrollable input vector (on which it is not possible to act, entailing the input boundary conditions of the sub-system),
y¹ represents the vector of the outputs of the system, it concatenates the different variables of interest, and the output boundary conditions (the outputs which act directly on the neighbouring systems)

It should be noted that not all of these vectors may exist within a system.

In the case of the sub-system 1 as a whole, y^{1←2} represents the input boundary condition vector imposed by the neighbouring sub-system.

The phase separator is the device in which the liquid heat-transfer fluid is separated from the gaseous heat-transfer fluid by gravity. A phase separator can be represented by the schematic diagram of FIG. 3. By using the notation of FIG. 3, the uncontrollable input, output, and state variables are written in the form of vectors, complying with the notation introduced by FIG. 2 (the exponent PS will be used to refer to the phase separator):

$${w}^{ps} = ( \begin{matrix}{M}_{in}^{L} \\ {M}_{in}^{G} \\ {P}_{in}^{C}\end{matrix} ) , \\ {y}^{ps} = ( \begin{matrix}h \\ {M}_{out}^{G} \\ {T}_{out}^{C} \\ {P}_{out}^{C}\end{matrix} ) , \\ {x}^{ps} = h \qquad ( 1 )$$

The algebraic or differential relations linking these different variables are given explicitly below. It may be noted that all the parameters used in the equations described have a physical sense and can be found in technical documentation for the hardware component.

It should be noted that the pressure which prevails in the phase separator is not a calculated variable (it is not a component of the state vector x^{ps}), but imposed by another sub-system via the input boundary condition Pₘ^{C}. Thus, in terms of pressure, this sub-system merely transmits to a neighbouring sub-system (via the output boundary condition Pₒᵤₜ^{C}) the pressure that it has received from a neighbouring sub-system (via its pressure input boundary condition Pᵢₙ^{C}).

The expansion valve is a sub-system which makes it possible to liquefy a part of the already cold gas passing it through.

Using the notation of FIG. 4, the uncontrollable input variables, the controllable input variables and the output variables are written in the form of vectors, complying with the notation introduced by FIG. 2 (the exponent vjt will be used to refer to the Joule-Thompson valve):

$${w}^{vjt} = ( \begin{matrix}{T}_{in}^{H} \\ {P}_{in}^{H} \\ {P}_{in}^{C}\end{matrix} ) , \\ {u}^{vjt} = P O S \\ {y}^{vjt} = ( \begin{matrix}{M}_{out}^{H} \\ {M}_{out}^{G} \\ {M}_{out}^{L}\end{matrix} ) \qquad ( 2 )$$

The equations relating these different variables are described below. All the parameters used are physical parameters. These entail algebraic equations processed as such.

The counter-current heat exchanger is the device charged with recovering the frigories from the coldest gas, so as to transmit them to the hottest gas. It is represented by the schematic diagram of FIG. 5. Using the notation of FIG. 5, the uncontrollable input variables and the output variables are written in the form of vectors, complying with the notation introduced by FIG. 2. The exponent ex is used to refer to the heat exchanger.

$$\begin{matrix}{w}^{ex} = ( \begin{matrix}{T}_{in}^{H} \\ {T}_{in}^{C} \\ {M}_{in}^{H} \\ {M}_{in}^{C} \\ {P}_{in}^{H} \\ {P}_{in}^{C}\end{matrix} ) , & ( 3 ) \\ {y}^{ex} = ( \begin{matrix}{T}_{out}^{H} \\ {T}_{out}^{C} \\ {M}_{out}^{H} \\ {M}_{out}^{C} \\ {P}_{out}^{H} \\ {P}_{out}^{C}\end{matrix} ) & \end{matrix}$$

The algebraic or differential equations relating these different variables are given explicitly below. It may be noted that all the parameters used in the equations described have a physical sense and can be found in technical documentation for the hardware component.

We may note that in contradistinction to what is known from the prior art, the output boundary conditions Pₒᵤₜ^{C} and Pₒᵤₜ^{H} are dependent on the input boundary conditions in terms of pressures Pᵢₙ^{C} and Pᵢₙ^{H} and flowrates Mᵢₙ^{C} and Mᵢₙ^{H}. The outgoing flowrates Mₒᵤₜ^{C} and Mₒᵤₜ^{H} are not generated by the pressure difference but simply imposed by the input boundary conditions Mᵢₙ^{C} and Mᵢₙ^{H}. To summarize, the pressure drop in the exchanger is considered to be a consequence of the passage of a fluid, and not the converse.

By inter-connecting or by combining the models of the three sub-systems (by linking all the boundary conditions of the sub-systems: the outputs on the inputs, the connections are those described by FIG. 1), it then becomes possible to obtain a state model in the form:

\dot{x}¹=ƒ¹(x¹,v¹,w¹,y^{1←2}) (4a)

y¹=g¹(x¹) (4b)

in which x¹ represents the state of the system, u¹ the controllable input vector, w¹ the uncontrollable input vector and y^{1←2} the input vector received from the neighbouring system.

The models determined are relevant in a control and/or observation strategy. It merely remains to ensure that the main dynamics are indeed taken into account by the model. Accordingly, we compare what is returned by the model if it is subjected to the same boundary conditions as an existing actual system. FIG. 6 presents the evolution of a few key variables of the system. The data measured on the real system bear the label “system” and the data obtained by simulation on the basis of the model bear the label “model”.

We can see in this figure that the main dynamics of the system have been correctly taken into account by the model.

Now that the system is modelled, it is necessary to obtain a steady operating state, indispensable for the synthesis of the gain of the observer.

Accordingly, it is sought to zero all the vectors \dot{x}^{PS}, \dot{x}^{JT} and \dot{x}^{EX}. Accordingly, we impose the outputs Pₒᵤₜ^{C}, Pₒᵤₜ^{H} and Tₒᵤₜ^{H} of the neighbouring sub-system (not represented), as well as the opening POS of the valve 3, and then we iterate on the power dissipated in the phase separator, until the vectors \dot{x}^{PS}, \dot{x}^{JT} and \dot{x}^{EX} become zero.

Once a steady state has been found, the linearized behaviour of the system around this operating point is extracted. We therefore seek to obtain, starting from the equations (4a, 4b), a linearized model in the form:

$$\begin{matrix}{\dot{x}}^{1} = A {\overline{x}}^{1} + [ {B}^{1} {B}^{1} {B}^{1 ← 2} ] ( \begin{matrix}{\overline{u}}^{1} \\ {\overline{w}}^{1} \\ {\overline{y}}^{1 ← 2}\end{matrix} ) & ( 5 a ) \\ {\overline{y}}^{1} = {C}^{1} {\overline{x}}^{1} & ( 5 b )\end{matrix}$$

Such a form is obtained by applying the methodology described below.

We now have a linear equivalent to the state model. It is therefore possible henceforth to use the theories applying to such a system, and especially to construct an observer.

The thermal loading observer can be used on another system, especially on the second system embodiment described above with reference to FIG. 7.

The observer can thereafter be used to observe a thermal loading on the basis of the model described previously. Recall that, even if, in the heat-transfer fluid bath, there is a dissipative device that is able to simulate a thermal loading, the latter is in fact unpredictable and unknown.

Accordingly, let us recall equations (5a, 5b), the notation for the state model of the Joule-Thompson cycle, linearized around an equilibrium point:

$$\begin{matrix}{\dot{x}}^{1} = A {\overline{x}}^{1} + [ {B}^{1} {B}^{1} {B}^{1 ← 2} ] ( \begin{matrix}{\overline{u}}^{1} \\ {\overline{w}}^{1} \\ {\overline{y}}^{1 ← 2}\end{matrix} ) & ( 6 a ) \\ {\overline{y}}^{1} = {C}^{1} {\dot{x}}^{1} & ( 6 b )\end{matrix}$$

As already stated, certain components of the vector \tilde{w}¹ are not measured (including the thermal loading). Also, certain boundary conditions \tilde{y}^{1←2} imposed by the previous sub-system are not measured either, and have a major influence on the manner of operation. Henceforth we use a new notation for the state model of the sub-system with, instead of the vectors \tilde{w}¹ and \tilde{y}^{1←2}, two uncontrollable input vectors, one measured, the other not. The system may then be rewritten:

$$\begin{matrix}{\dot{x}}^{1} = A {\overline{x}}^{1} + [ {B}^{1} {B}_{m}^{1} {B}_{um}^{1} ] ( \begin{matrix}{\overline{u}}^{1} \\ {\overline{w}}_{mes}^{1} \\ {\overline{w}}_{umes}^{1}\end{matrix} ) & ( 7 a ) \\ {\overline{y}}^{1} = {C}^{1} {\overline{x}}^{1} & ( 7 b )\end{matrix}$$

wₘₑₛ¹ being the vector concatenating the measured components, w₁^{umes} the non-measured components. The vector of non-measured components is defined as a component of the state of the system. The augmented system may then be written:

$$\begin{matrix}( \begin{matrix}{\dot{x}}^{1} \\ {\dot{w}}_{um}^{1}\end{matrix} ) = \underbrace{[ \begin{matrix}{A}^{1} & {B}_{um}^{1} \\ 0 & 0\end{matrix} ]}_{{A}_{aug}^{1}} \underbrace{( \begin{matrix}{\overline{x}}^{1} \\ {\overline{w}}_{um}^{1}\end{matrix} )}_{{ξ}^{1}} + \underbrace{[ \begin{matrix}{B}^{1} & {B}_{m}^{1} \\ 0 & 0\end{matrix} ]}_{{B}_{aug}^{1}} \underbrace{( \begin{matrix}{\overline{u}}^{1} \\ {\overline{w}}_{m}^{1}\end{matrix} )}_{{u}^{1}} & ( 8 a ) \\ {\overline{y}}^{1} = \underbrace{[ \begin{matrix}{C}^{1} & 0\end{matrix} ]}_{{C}_{aug}^{1}} ( \begin{matrix}{\overline{x}}^{1} \\ {\overline{w}}_{um}^{1}\end{matrix} ) & ( 8 b )\end{matrix}$$

i.e. in compact form

\dot{ξ}¹=A_{avg}¹ξ¹+B_{avg}¹μ¹ (9a)

y̅¹=C_{avg}¹ξ¹ (9b)

The resulting system is an invariant linear system, for which there exists a Kalman estimator obtained by solving the Riccati equation (under the MatLab development environment, we will be able use the control L¹=lqr(A_{avg}¹^{^{T}},C_{avg}¹^{^{T}},Q¹,R¹)^{T} in which Q¹ and R¹ are weighting matrices). The observability matrix of this system is of full rank: each of the non-measured states can be estimated by virtue of the measurements vector.

We therefore obtain a correction term L¹ that it remains to use. Two out of several modes of implementation are particularly beneficial, the linear observer and the non-linear observer.

The correction term L¹ is used on the extended state model defined by equations (8a, 8b). The differential equation yielding the thermal loadings dissipated in the bath may thus be expressed as:

{dot over (\hat{ξ}¹=(A_{avg}¹−L¹C_{avg}^{I})\dot{ξ}¹+B_{avg}¹μₑₓₚ¹+L¹yₑₓₚ¹ (10)

in which μₑₓₚ¹ and yₑₓₚ¹ represent the data of measurements originating from experiment.

It is possible to observe the result of such an observation strategy on an experiment that took place on the machine.

The amount of heat per unit time which is applied to the value bath is a priori unknown, but the test system possesses a heating device having the same effect. It is therefore possible to compare the observation result with the value actually applied. FIG. 8 presents a result, the curve referenced w¹ representing the power afforded by the heating device and the curve referenced ŵ¹ representing the power estimated by the linear observation. We may note that in this figure, the thermal loading simulated by the heating device is correctly estimated around the operating point. On the other hand, if the system deviates a great deal from its initial operating point, the observer returns a systematically lower discrepancy. A second observation structure, based on the complete (and more only linearized) knowledge of the model is therefore set up.

We shall now use the correction gain L¹ on the non-linear model stated by equations (4a, 4b). The correction term L¹ is therefore used on the extended version of the function ƒ¹, called ƒ̅¹, according to the definition of the extended state, given by equations (8a, 8b). Thus, the observer is expressed by virtue of the following differential equation:

{dot over (\hat{ξ}= ƒ̅¹( ξ̅¹,μₑₓₚ¹)−L(yₑₓₚ¹−g¹(\dot{ξ}¹,μₑₓₚ¹)) (11)

yₑₓₚ¹ and μₑₓₚ¹ represent the data arriving from experiment. We recall that yₑₓₚ¹ concatenates the measurements while μₑₓₚ¹ represents the measured boundary conditions (including the control).

After implementation of the observer, we concentrate on the observation result for the amount of heat per unit time which is applied to the bath. FIG. 9 presents the results. We may note that in this figure, the thermal loading simulated by the heating device is correctly estimated. The curve referenced w¹ represents the power afforded by the heating device and the curve referenced ŵ¹ represents the power estimated by the linear observation.

### Modellings of the Sub-Systems:

An aim of the invention is to decrease the number of states of the system taken into account so as to facilitate the adjustment and the execution of the control or, stated otherwise, to decrease the number of differential equations used in the model.

Using the notation introduced by FIG. 3, the dynamic behaviour of the sub-system is expressed. The amount of liquid mass present in the phase separator may be written:

[symbol]

^{L}=ρ^{L}·S·h (12)

where ρ^{L}, S and h are respectively the density of the fluid, the area of the horizontal cross section of the reservoir of the separator and the height of the liquid fluid level in the reservoir. By differentiating equation (12) with respect to time, we get:

$$\dot{h} = \frac{{\dot{ℳ}}^{L} - {\dot{ρ}}^{L} \cdot S \cdot h}{{ρ}^{L} \cdot S} \qquad ( 13 )$$

And with the principle of conservation of mass:

[symbol]

^{L}=Mᵢₙ^{L}−M^{vap} (14)

The amount of vapourized fluid is equal to:

$${M}^{vap} = \frac{\dot{Q}}{{L}_{v}} \qquad ( 15 )$$

where \dot{Q} (simulated in the example) and Lᵥ correspond to the thermal loading applied in the fluid bath and the latent heat of vapourization of the fluid. By assuming that density variations can be neglected in the case of a weak variation in pressure and by combining equations (13), (14), (15), we obtain:

$$\dot{h} = \frac{{M}_{i n}^{L} - \frac{\dot{Q}}{{L}_{v}}}{{ρ}^{L} \cdot S} \qquad ( 16 )$$

with a similar approach, the amount of gas in the reservoir can be expressed as follows:

[symbol]

^{G}=ρ^{G}·S·(hₘₐₓ−h) (17)

in which hₘₐₓ is the height of liquid fluid in the reservoir. By differentiating equation (17) with respect to time, we obtain:

[symbol]

^{G}=\dot{ρ}^{G}·S·(hₘₐₓ−h)−ρ^{G}·S·\dot{h} (18)

And with the principle of conservation of mass:

[symbol]

^{G}=Mᵢₙ^{G}+M^{vap}−Mₒᵤₜ^{C} (19)

Finally, by combining equations (17), (18) and (19), we obtain:

$${M}_{out}^{C} = {M}_{i n}^{G} + \frac{\dot{Q}}{{L}_{v}} - {ρ}^{G} \cdot S \cdot ( h - {h}_{max} ) + \frac{{ρ}^{G}}{{ρ}^{L}} ( {M}_{i n}^{L} - \frac{\dot{Q}}{{L}_{v}} ) \qquad ( 20 )$$

The temperature of the outgoing flow, under a vapour saturation assumption, is given algebraically by Hepack© (software from the company CRYODATA):

Tₒᵤₜ^{C}=ƒ(Pᵢₙ^{C}) (21)

The output pressure is considered equal to the input pressure

Pₒᵤₜ^{C}=Pᵢₙ^{C} (22)

According to the boundary conditions Tᵢₙ^{H}, Tᵢₙ^{C}, Mᵢₙ^{H}, Mᵢₙ^{C}, Pᵢₙ^{H} and Pᵢₙ^{C} represented in FIG. 5, the model of the exchanger defines the output temperature Tₒᵤₜ^{H} and Tₒᵤₜ^{C}, the pressures Pₒᵤₜ^{H} and Pₒᵤₜ^{C}, the flowrates Mₒᵤₜ^{H} and Mₒᵤₜ^{C}. The model is established using the following assumptions:
The pressures are assumed to decrease linearly in the pipes,
The flowrates are assumed to be constant in the pipes,
The longitudinal conductivity and the specific heat of aluminium are assumed to be negligible.

With the aim of expressing the derivative of the temperature relative to time alone, a spatial discretization must be carried out, using a finite number of elementary zones as represented in FIG. 10. In this figure, Tᵢ^{H} and Tⱼ^{C} are the temperatures at the level of the zones i and N−i+1. \dot{Q}ᵢ represents the heat flows in each of the zones. T₀^{H} is equal to Tᵢₙ^{H} and T₀^{C} is equal to Tᵢₙ^{C}.

Each zone is traversed by two flows, thermally coupled with one another. The dynamic behaviour of zone i can be described by the following system of differential equations:

$$\begin{matrix}\frac{{ρ}_{i}^{H} {Cp}_{i}^{H} {V}^{H}}{N} {\dot{T}}_{i}^{H} = {M}^{H} {Cp}_{i}^{H} ( {T}_{i - 1}^{H} - {T}_{i}^{H} ) - {\dot{Q}}_{i} & ( 23 a ) \\ \frac{{ρ}_{j}^{C} {Cp}_{j}^{C} {V}^{C}}{N} {\dot{T}}_{j}^{C } = {M}^{C} {Cp}_{j}^{C} ( {T}_{j - 1}^{C} - {T}_{j}^{C} ) + {\dot{Q}}_{i} & ( 23 b ) \\ {\dot{Q}}_{i} = \frac{kS Δ {T}_{M}}{N} , \\ j = N - i + 1 & ( 23 c )\end{matrix}$$

where ρ and Cₚ, are the properties of the heat-transfer fluid, V is the volume of gaseous fluid contained in the exchanger, S is the exchange surface area and k the overall heat transfer coefficient. ΔT_{M} is the mean temperature difference between the hot fluid and the cold fluid.

According to the modelling assumptions mentioned hereinabove, the outgoing flowrates are equal to the incoming flowrates:

Mₒᵤₜ^{H}=Mᵢₙ^{H}=M^{H}, Mₒᵤₜ^{C}=Mᵢₙ^{C}=M^{C} (24)

The output pressures can be modelled by:

P_{N}^{H}=P₀^{H}−K^{H}·M^{H}^{²}, P_{N}^{C}=P₀^{C}+K^{C}·M^{C}^{²} (25)

where K^{H} and K^{C} are the coefficients of pressure drops due to friction.

Hereinafter, the dynamic model of the exchanger is expressed using the compact form:

\dot{x}^{ex}=ƒ^{ex}(x^{ex},w^{ex}) (26a)

y^{ex}=g(x^{ex},w^{ex}) (26b)

According to the boundary conditions mentioned in FIG. 4, the model of the expansion valve of Joule-Thompson type expresses the flowrate Mₒᵤₜ^{H} through the valve and χ the weight titer of the mixture. The control of the valve is called POS. As for any other control valve, the flow Mₒᵤₜ^{H} through the valve can be expressed by:

$$\begin{matrix}{M}_{out}^{H} = 2.4 \cdot {10}^{- 5} \cdot {C}_{v} \cdot ( 1 - \frac{X}{3 \cdot {X}_{c}} ) \sqrt{ρ \cdot {P}_{i n}^{H} \cdot X} & ( 27 a ) \\ {C}_{v} = \frac{{Cv}_{man}}{{R}_{v}} ( exp ( \frac{POS}{100} log {R}_{v} ) - ( 1 - \frac{POS}{100} ) ) & ( 27 b ) \\ X = min ( \frac{{P}_{i n}^{H} - {P}_{i n}^{C}}{{P}_{i n}^{H}} , {X}_{c} ) , \\ {X}_{c} = \frac{7}{1.4} {X}_{t} & ( 27 c )\end{matrix}$$

where γ is the ratio of the thermal capacity at constant pressure to the thermal capacity at constant volume and ρ the density of the fluid, both of them under pressure Pᵢₙ^{H} and temperature Tᵢₙ^{H}. Xⁱ is a constant given by the manufacturer of the valve. R^{v} and Cvₘₐₓ are valve dimensioning constants, respectively the ratio of maximum to minimum flowrates allowed by the valve (or “rangeability”) and the flow coefficient, X and Xc being ratios of pressures.

Part of the gaseous flow expressed in equations (27a, 27b and 27c) is liquefied during expansion. Assuming an isenthalpic expansion to gas-liquid equilibrium, we may write:

Hⁱⁿ=Hₒᵤₜ=χ·H^{G}+(1−χ)·Hₒᵤₜ^{L} (28)

where Hᵢₙ and Hₒᵤₜ are the enthalpies before and after the expansions; Hₒᵤₜ^{G} and Hₒᵤₜ^{L} are the enthalpies of the saturated gas and of the liquid. Consequently, the ratio of phases in the mixture can be written:

$$X = \frac{{H}_{i n} - {H}_{out}^{L}}{{H}_{out}^{G} - {H}_{out}^{L}} \qquad ( 29 )$$

Finally, the outgoing gas and liquid flows can be written:

Mₒᵤₜ^{G}=(1−χ)·Mₒᵤₜ^{H}, Mₒᵤₜ^{L}=χ·Mₒᵤₜ^{H} (30)

Subsequently, the model of the valve is written in compact form:

y^{vjt}=ƒ(u^{vjt},w^{vjt}) (31)

We recall here the notation and methodology for linearizing a dynamic system around an operating point. Accordingly, we begin by stating a generic non-linear system:

\dot{x}=ƒ(x,u) (32a)

y=g(x,u) (32b)

in which x represents the state of the system, u the controllable input and y the measured outputs. We seek to identify the linear model around an operating point, which is characterized by:

\dot{x}=0=ƒ(x₀,u₀) (33a)

y=y₀=g(x₀,u₀) (33b)

We recall Taylor's identity, limited to first order. Let h be a function of two variables, p and q. Its expansion about p₀ and q₀ may be written:

$$h ( p , q ) {\vert}_{{p}_{o} , {q}_{o}} = h ( {p}_{o} , {q}_{o} ) + ( p - {p}_{o} ) \frac{\partial h ( p , q )}{\partial p} {\vert}_{p = {p}_{o} , q = {q}_{o}} + ( q - {q}_{o} ) \frac{\partial h ( p , q )}{\partial q} {\vert}_{p = {p}_{o} , q = {q}_{o}} \qquad ( 34 )$$

Now defining the slack variables:

\tilde{x}=x−x₀, ũ=u−u₀, \tilde{y}=y−y₀ (35)

Thus, by applying equation (34) to the equation system (32a, 32b) and by using the notation introduced by equation (35), we obtain:

\dot{x}=A\tilde{x}+Bũ (36a)

\tilde{y}=C\tilde{x}+Dũ (36b)

with

$$A = \frac{\partial f ( x , u )}{\partial x} {\vert}_{{x}_{o} , {u}_{o}} \\ B = \frac{\partial f ( x , u )}{\partial u} {\vert}_{{x}_{o} , {u}_{o}} \\ C = \frac{\partial g ( x , u )}{\partial x} {\vert}_{{x}_{o} , {u}_{o}} \\ D = \frac{\partial f ( w , u )}{\partial u} {\vert}_{{x}_{o} , {u}_{o}} \qquad ( 37 )$$

In certain cases, the formal calculation of (37) may turn out to be tricky, or irrelevant: the following approximation will then be admitted:

$$\frac{\partial f ( x )}{\partial x} {\vert}_{{x}_{o}} = \frac{Δ f ( x )}{Δ x} {\vert}_{{x}_{o}} = \frac{f ( {x}_{0} + h ) - f ( {x}_{0} + h )}{h} \qquad ( 38 )$$

This approximation is justified since, by definition:

$$\frac{\partial f ( x )}{\partial x} {\vert}_{{x}_{a}} = {lim}_{h \to 0} \frac{f ( {x}_{0} + h ) - f ( {x}_{0} )}{h} \qquad ( 39 )$$

It will suffice to choose h sufficiently small for the approximation to be valid.

The invention further relates to a method for configuring the control device 6 of the thermodynamic system 1, in particular a thermohydraulic system, especially of the cryorefrigerator system. The method comprises the following phases:
Implementation of the method for determining the model of the system;
Generation of an observer by using the model determined in the previous phase.

This observer is thereafter implemented in the control device.

The invention further relates to a method of control of the thermodynamic system 1, in particular thermohydraulic system, especially of the cryorefrigerator system. The method comprises the use of an observer generated by the implementation of the configuration method.

In particular, “first boundary condition linked to a second boundary condition”, is understood to mean for example that the first boundary condition is determined by the second boundary condition or that the second boundary condition is determined by the first boundary condition.

1. Method for configuring a control device (6) of a thermodynamic system (1), in particular a thermohydraulic system, especially of a cryorefrigerator system, wherein the method comprises the following phases:
Implementation of a method of determination of a model of a thermodynamic system, wherein the determination method comprises a decomposition of the system into sub-systems (2, 3, 4, 5; 21, 31, 41, 32, 42) each having boundary conditions, wherein:
output, respectively input, boundary conditions of a sub-system are linked to input, respectively output, boundary conditions of a neighbouring sub-system,
the boundary conditions pertain at least to an amount of fluid per unit time and to a pair of physical quantities defining the thermodynamic state of the fluid;
Generation of an observer by using the model determined in the previous phase.

2. Method for configuring according to claim 1, wherein the pair of physical quantities comprises the temperature of the fluid and/or the pressure of the fluid.

3. Method for configuring according to claim 1, wherein use is made of physical models of the sub-systems based on the operation of each sub-system.

4. Method for configuring according to claim 1, wherein a step of linearizing the physical models of the sub-systems is implemented.

5. Method for configuring according to claim 1, wherein a step of initializing the physical models of the sub-systems at an operating point of the system, especially at a steady operating point of the system, is implemented.

6. Method for configuring according to claim 1, wherein a step of determining the model of the system by combining the models of the sub-systems is implemented.

7. Method of control of a thermodynamic system (1), in particular a thermohydraulic system, especially of a cryorefrigerator system, comprising the use of an observer generated by implementing the method according to claim 1.

8. Recording medium (62) readable by a processor (61) on which are recorded data defining a model of a thermodynamic system (1; 11), in particular a thermohydraulic system, especially of a cryorefrigerator system, the model being obtained by implementing the method according to claim 1.

9. Control device (6) of a thermodynamic system (1), in particular a thermohydraulic system, especially of a cryorefrigerator system, comprising hardware and/or software elements (61, 62) for using a model obtained by the implementation of the method according to claim 1.

10. Device according to claim 9, wherein the hardware and/or software means comprise hardware and/or software elements for determining at least one control by using a model obtained by the implementation of the method for configuring a control device (6) of a thermodynamic system (1), in particular a thermohydraulic system, especially of a cryorefrigerator system, wherein the method comprises the following phases:
Implementation of a method of determination of a model of a thermodynamic system, wherein the determination method comprises a decomposition of the system into sub-systems (2, 3, 4, 5; 21, 31, 41, 32, 42) each having boundary conditions, wherein:
output, respectively input, boundary conditions of a sub-system are linked to input, respectively output, boundary conditions of a neighbouring sub-system,
the boundary conditions pertain at least to an amount of fluid per unit time and to a pair of physical quantities defining the thermodynamic state of the fluid;
Generation of an observer by using the model determined in the previous phase.

11. Device according to claim 9, wherein the hardware and/or software means comprise a recording medium (62) readable by a processor (61) on which are recorded data defining a model of a thermodynamic system (1; 11), in particular a thermohydraulic system, especially of a cryorefrigerator system, the model being obtained by implementing the method for configuring a control device (6) of a thermodynamic system (1), in particular a thermohydraulic system, especially of a cryorefrigerator system, wherein the method comprises the following phases:
Implementation of a method of determination of a model of a thermodynamic system, wherein the determination method comprises a decomposition of the system into sub-systems (2, 3, 4, 5; 21, 31, 41, 32, 42) each having boundary conditions, wherein:
output, respectively input, boundary conditions of a sub-system are linked to input, respectively output, boundary conditions of a neighbouring sub-system,
the boundary conditions pertain at least to an amount of fluid per unit time and to a pair of physical quantities defining the thermodynamic state of the fluid;
Generation of an observer by using the model determined in the previous phase, like a memory.

12. Thermodynamic system (1; 11), in particular a thermohydraulic system, especially a cryorefrigerator system, comprising a control device (6) according to claim 9.
